(19) United States
(12) Patent Application Publication
(10) Pub. No.: US 2024/0047729 A1
(43) Pub. Date: Feb. 8, 2024

(54) APPARATUS FOR MAKING AN ELECTRODE-ELECTROLYTE STRUCTURE

(71) Applicant: Dyson Technology Limited, Wiltshire (GB)

(72) Inventors: Reza PAKZAD, Swindon (GB); Matthew Robert ROBERTS, Oxford (GB); Steven ROBSON, Bristol (GB)

(73) Assignee: Dyson Technology Limited, Wiltshire (GB)

(21) Appl. No.: 18/266,578

(22) PCT Filed: Nov. 29, 2021
(86) PCT No.: PCT/GB2021/053103

§ 371 Date: Jun. 9, 2023

(30) Foreign Application Priority Data
Dec. 17, 2020 (GB) 2020034.1

(51) Int. Cl. H01M 10/04; H01M 10/0565; H01M 10/052; H01M 10/058; H01M 4/04; B29C 48/025; B29C 48/21; B29C 48/154

(52) U.S. Cl. CPC H01M 10/0404; H01M 10/0565; H01M 10/052; H01M 10/058; H01M 10/0468; H01M 4/0404; B29C 48/0255; B29C 48/21; B29C 48/154; B29L 2009/005

(57) ABSTRACT

Apparatus for making an electrode-electrolyte structure includes: a die head defining a substrate pathway for passage of an electrode substrate through the die head from a substrate inlet to a substrate outlet, and an electrolyte pathway for passage of an electrolyte gel through the die head; an electrode feeder for feeding an electrode substrate along the substrate pathway; and an electrolyte feeder for feeding a polymer gel electrolyte along the electrolyte pathway. The electrolyte pathway is arranged to meet the substrate pathway at a junction arranged between the substrate inlet and the substrate outlet, to extrude the electrolyte onto the electrode substrate as it is fed along the substrate pathway.

### FIELD OF THE INVENTION

The invention relates to apparatus for making an electrode-electrolyte structure by applying a polymer gel electrolyte to an electrode substrate, and to a method of applying a polymer gel electrolyte to an electrode substrate.

### INTRODUCTION

Traditional batteries featuring a liquid electrolyte typically comprise solid anode and cathode layers with a liquid electrolyte between them. Each anode or cathode layer is usually formed onto a foil by slurry casting, and the foil acts as a current collector for the respective electrode.

Polymer gel batteries are emerging as promising alternatives to these traditional liquid electrolyte batteries. Such battery systems use a polymer gel as the electrolyte and/or electrodes. The matrix comprises a polymer and solvent, and has a gel-like consistency: i.e. it is non-fluid, but is also flexible and non-brittle. Different solid powder additives can be impregnated into the gel matrix, so that the gel can act variously as an electrolyte, cathode or anode, depending on the impregnated material.

The various polymer gel constituents (anode, cathode and electrolyte) can be formed by extrusion of the polymer gel. Extrusion is a simple method of manufacturing, which has some benefits over more traditional electrode deposition methods such as slurry casting. However, as the loading of solid powder increases, viscosity of the gel increases, and extrusion becomes more difficult. It can also be more difficult to achieve consistent and predictable results with extrusion than with well-known traditional methods such as slurry casting.

It is against this background that the invention has been devised.

### SUMMARY OF THE INVENTION

Against this background, from a first aspect, the invention resides in a method of making an electrode-electrolyte structure. The method comprises: providing a slurry-cast electrode comprising a current collector layer and an electrode layer formed on the current collector layer by slurry casting, and extruding a polymer gel electrolyte onto the electrode layer to form an electrode-electrolyte structure.

The method provides a way of making an electrode-electrolyte structure (i.e. a composite structure comprising at least an electrode and an electrolyte) that combines the benefits of a slurry cast electrode with an extruded gel electrolyte. The slurry cast electrode can be provided immediately after slurry casting, or it can be stored after slurry casting if desired. The polymer gel electrolyte can then be extruded onto the slurry cast electrode in a quick and simple extrusion process.

The method may comprise forming the slurry cast electrode by slurry casting the electrode layer onto the current collector layer. In this case, the process of extruding the electrolyte can take place immediately after slurry casting the electrode, avoiding the need for electrode storage, and allowing a single continuous process for making the electrode electrolyte structure.

The electrode layer may comprise an electrode surface having surface pores, and the method may comprise extruding the polymer gel electrolyte onto the electrode surface such that the polymer gel electrolyte at least partially fills the surface pores. This is particularly advantageous for both effective adhesion of the electrolyte to the electrode, and for ensuring effective and continuous contact between the electrolyte and the electrode, which is important for cell performance.

For particularly improved adhesion between the electrolyte and the electrode, the method may comprise applying pressure to the polymer gel electrolyte during or after extrusion, the applied pressure having a component that is substantially perpendicular to an electrode-electrolyte interface. Additionally or alternatively, the method may comprise heating the polymer gel electrolyte during and/or after extrusion.

The method may comprise feeding the electrode through a die head and extruding the polymer gel electrolyte onto the electrode layer as the electrode is fed through the die head. Using a die head in this way is particularly convenient as it allows close control of the relative positions of the electrode and electrolyte during deposition, as well as the volume of electrolyte. Electrolyte can also be advantageously contained in the die head to reduce solvent loss during processing.

The electrode may be an anode or a cathode.

The method may comprise providing first and second slurry-cast electrodes, each comprising a current collector layer and an electrode layer formed on the current collector layer by slurry casting; and extruding a polymer gel electrolyte between the electrode layers of the first and second slurry-cast electrodes to form the electrode-electrolyte structure. Such a process allows both electrodes and an electrolyte to be assembled together in a single process step, in which the electrolyte is sandwiched between the electrodes. This single-step process allows quick and easy assembly.

The method may comprise feeding the first and second electrodes through a die head with a spacing between the electrodes, and extruding the polymer gel electrolyte into the spacing between the electrodes as the electrodes are fed through the die head. Extruding the electrolyte directly into the spacing in this way is particularly quick and simple, and allow for particularly effective adhesion between the electrodes and electrolyte.

The first electrode may be an anode and the second electrode may be a cathode, or vice versa.

The invention also extends to an electrode-electrolyte structure comprising: a slurry-cast electrode comprising a current collector layer and an electrode layer formed on the current collector layer by slurry casting; and an electrolyte layer arranged over the electrode layer, the electrolyte layer comprising an extruded polymer gel electrolyte.

The electrode layer may comprise an electrode surface having surface pores. The gel electrolyte may at least partially fill the surface pores. This ensures particularly effective contact and adhesion between the electrode and the electrolyte, which improves cell performance.

The electrode layer may be an anode layer or a cathode layer.

The invention further extends to a cell comprising the electrode-electrolyte structure above, and a further slurry-cast electrode. The further slurry cast electrode comprises a further current collector layer and a further electrode layer formed on the further current collector layer by slurry casting. The electrolyte layer is arranged between the electrode layer of the slurry-cast electrode and the further electrode layer of the further slurry-cast electrode. In this way, the extruded gel polymer electrolyte layer is sandwiched between the slurry-cast electrode layers.

The electrode layer may be an anode and the further electrode layer may be a cathode, or vice versa.

From another aspect, the invention resides in apparatus for applying a polymer gel electrolyte to an electrode substrate to make an electrode-electrolyte structure, the apparatus comprising:
a die head defining a substrate pathway for passage of the electrode substrate through the die head from a substrate inlet to a substrate outlet, and an electrolyte pathway for passage of the electrolyte gel through the die head;
an electrode feeder for feeding the electrode substrate along the substrate pathway, the electrode feeder preferably comprising a roll of electrode substrate; and
an electrolyte feeder for feeding the polymer gel electrolyte along the electrolyte pathway;
wherein the electrolyte pathway is arranged to meet the substrate pathway at a junction arranged between the substrate inlet and the substrate outlet, to extrude the electrolyte onto the electrode substrate as it is fed along the substrate pathway.

The apparatus provides a convenient means for extruding a polymer gel electrolyte onto an electrode. Containing the electrolyte in the die head minimises loss of solvent from the electrolyte during processing. The die head also allows careful control of the relative position of the electrode and electrolyte, allowing consistent and precise assembly of the electrode-electrolyte structure.

The die head may define a process direction. The process direction may be defined as the overall direction of the components during processing between proximal and distal ends of the die head.

The electrode pathway may comprise an entry section extending from the substrate inlet to the junction, which may be arranged at an acute angle to the process direction. The electrode pathway may also comprise an exit section extending from the junction to the substrate outlet, which may be arranged substantially parallel to the process direction. In this way, the electrode pathway may transition from the entry section to the exit section at the junction. The change in angle of the pathway is a particularly simple means of allowing the electrode pathway to converge with the electrolyte pathway, so that the electrolyte can be extruded onto the electrode at the junction.

The electrode pathway may comprise first and second entry sections arranged to feed first and second electrode substrates to opposite sides of the exit section at the junction. In this way, first and second electrodes (for example an anode and a cathode) can be fed into the die head from different direction, and the electrolyte can be extruded between the electrodes. This provides a convenient means for assembling a cell, with an anode, cathode and electrode, in a single process stage.

At least a part of the electrolyte pathway may be parallel to and continuous with the exit section of the electrode pathway. In this way the electrolyte is fed smoothly and continuously onto the electrode.

The substrate pathway may be defined by a substrate passage formed in the die head. A substrate passage in the die head contains and protects the electrode substrate during processing, avoiding contamination of the electrode surface.

The electrolyte pathway may be defined by an electrolyte passage formed in the die head. This passage can contain the electrolyte particularly effectively, reducing contamination and solvent loss. The electrolyte passage may converge with the substrate passage at the junction, so as to provide continuous containment and protection as the electrolyte is fed onto the electrode.

The electrolyte passage may meet the entry portion of the substrate passage at an acute angle to define an extrusion edge. This extrusion edge discourages ingress of the electrolyte into the entry portion of the substrate passage.

The electrolyte passage may define a dwell chamber for receiving excess electrolyte. This can accommodate any mismatch in the flow rate of the electrolyte into the electrolyte passage and the extrusion rate of the electrolyte out of the electrolyte passage.

The substrate passage may comprise one or more sealing means for sealing the entry section of the substrate passage from the electrolyte passage. This guards against the electrolyte entering the substrate passage and contaminating the electrode substrate.

The substrate passage may comprise a plurality of sealing means spaced successively along the entry section moving away from the junction. This provides additional protection against leakage form the junction region.

The or each sealing means may comprise a brush seal, which is a particularly simple and effective sealing means.

To reduce solvent loss in the junction region, the junction may be pressurised to a junction pressure greater than atmospheric pressure. Where a sealing means is used, a pressure behind the sealing means may be less than the junction pressure. Where multiple sealing means are used, a pressure behind successive sealing means may decrease moving away from the junction.

The die head may comprise mounting means for movably mounting the die head on a support. This advantageously allows the die head to be removed and replaced, and to be moved relative to the support into a desired position.

The die head may comprise a plurality of sections arrangeable to define the electrolyte pathway and the substrate pathway therebetween. The sections are preferably separable. This is a particularly convenient means of providing the pathways, as the size of the pathways can be adjusted by relative movement between the sections, and the sections can be separated to provide access to the pathways for maintenance and cleaning.

Each section may comprise a mounting means for movably mounting the section on the support, thereby making it particularly easy to move the die head sections to adjust dimensions of the electrolyte pathway and the substrate pathway.

The die head may comprise first and second proximal sections and first and second distal sections, wherein the electrolyte pathway is defined between the first and second proximal sections, and wherein the substrate pathway is defined at least partially between the first proximal section and the first distal section, and at least partially between the first distal section and the second distal section. Where the substrate pathway comprises first and second converging entry sections, the substrate pathway may also be defined at least partially between the second proximal section and the second distal section.

In an embodiment suitable for making more complex electrode-electrolyte structures, with multiple electrolyte layers, the die head may comprises a first die head part defining the electrolyte pathway and the substrate pathway described above, and a second die head part. The second die head part may define: a first further substrate pathway configured to receive an electrode-electrolyte structure produced by the first die head part; a further electrolyte pathway configured to allow passage of a polymer gel electrolyte through the second die head part; and a second further substrate pathway configured to receive a further electrode substrate.

The further electrolyte pathway may be arranged to meet the first further substrate pathway at a first junction, to extrude the polymer gel electrolyte onto the electrode-electrolyte structure as it is fed along the first further substrate pathway. The further electrolyte pathway may be configured to meet the second further substrate pathway at a second junction downstream of the first junction, to arrange the further electrode substrate over the polymer gel electrolyte, thereby producing an electrode-electrolyte structure having multiple electrolyte layers.

Such an apparatus allows multiple electrolyte layers, and multiple electrode layers, to be arranged into a structure in a single piece apparatus, without the need to carry out separate steps.

The second die head part may define a process direction. The further electrolyte pathway may comprises an entry section that extends towards the first junction at an acute angle to the process direction, and an exit section that extends between the first junction and the second junction in a direction parallel to the exit section. This change in angle provides a convenient means for allowing the electrolyte path to converge with the first further substrate path.

The first further substrate pathway may be parallel to and continuous with the exit section of the further electrolyte pathway. This allows the electrode-electrolyte structure to be fed smoothly and continuously through the die head as the electrolyte is extruded onto it.

The die head parts may be part of a single continuous die head. In other embodiments, the first die head part and the second die head part may be defined by separable die head modules. In this case, the modules may be arranged adjacent to each other, or the modules may be separated from each other by other components. A modular system is particularly advantageous as it allows multiple die head parts to be assembled together as desired to construct any desired arrangement and number of electrode and electrolyte layers.

For particular ease of use of the modular system, the apparatus may further comprise a support, and releasable mounting means for movably mounting each of the first and second die head modules to the support.

To securely locate the first and second die head modules relative to each other, and in particular to align the various passages easily, the first and second die head modules may comprise co-operable locating formations on respective proximal and/or distal ends. The locating formations may comprise a projection and corresponding recess.

From a further aspect, the present invention provides a method of applying a polymer gel electrolyte to an electrode substrate to make an electrode-electrolyte structure, the method comprising the steps of:
providing a die head defining a substrate pathway for passage of the electrode substrate through the die head from a substrate inlet to a substrate outlet, and an electrolyte pathway for passage of the electrolyte gel through the die head;
feeding the electrode substrate along the substrate pathway from a roll of electrode substrate; and
feeding the polymer gel electrolyte along the electrolyte pathway;
wherein the electrolyte pathway is arranged to meet the substrate pathway at a junction arranged between the substrate inlet and the substrate outlet, to extrude the electrolyte onto the electrode substrate as it is fed along the substrate pathway.

Preferred and/or optional features of one embodiment or aspect may be used alone, or in appropriate combination, with another embodiment or aspect also.

### DESCRIPTION OF THE FIGURES

Embodiments of the Invention will be now be described, by way of example only, with reference to the accompanying drawings, in which:

FIGS. 1 and 2 are perspective views of electrode-electrolyte structures;

FIGS. 3 to 5 are schematic views of stages in making the electrode-electrolyte structure of FIG. 1;

FIG. 6 is a partial enlarged view of an electrode-electrolyte interface of the electrode-electrolyte structure of FIG. 1 or FIG. 2;

FIG. 7 is a schematic cross section of apparatus for making the electrode-electrolyte structure of FIG. 2;

FIG. 8 is the schematic cross section of FIG. 7, showing pathways in the die head of the apparatus;

FIG. 9 is a partial enlarged view of a junction region in the die head of FIG. 8;

FIG. 10 is a partial enlarged view of the junction region of FIG. 9 while the apparatus is in use;

FIG. 11 is a schematic cross section of a modular apparatus for making a complex electrode-electrolyte structure having multiple electrolyte layers, the apparatus having first and second die head parts;

FIG. 12 is a schematic cross section of the second die head part of FIG. 11, showing pathways in the second die head part;

FIG. 13 is a schematic cross section of the second die head part of FIG. 12; and

FIG. 14 is a partial enlarged view of the junction region of FIG. 13 while the second die head part is in use.

### DETAILED DESCRIPTION OF EMBODIMENTS OF THE INVENTION

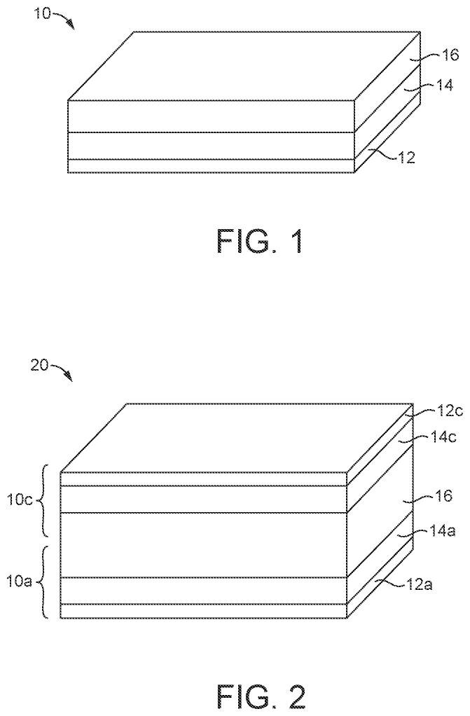

FIG. 1 illustrates an electrode-electrolyte structure 10. The electrode-electrolyte structure 10 comprises a current collector 12, an electrode 14 arranged over the current collector, which may be an anode or a cathode, and an electrolyte 16 arranged over the electrode 14. The electrode 14 is a slurry-cast electrode that has been formed on the current collector layer 12 by slurry casting. The electrolyte 16 is a gel electrolyte that has been formed by extrusion.

Two such electrode-electrolyte structures 10a, 10c, may be incorporated into a battery cell structure 20, as shown in FIG. 2. In this case, a first electrode-electrolyte structure forms an anode structure 10a, in which the electrode is an anode 14a and the current collector is an anode current collector 12a. A second electrode-electrolyte structure forms the cathode structure 10c, in which the electrode is a cathode 14c and the current collector is a cathode current collector 12c. A gel electrolyte 16 is provided between the anode 14a and the cathode 14c. The anode 14a and cathode 14c are each formed on their respective current collector layers 12a, 12c by slurry casting, while the electrolyte 16 is a gel electrolyte formed by extrusion.

The electrolyte layer 16 may be formed by joining two electrolyte sub-layers. This may be the case if two structures of the type shown in FIG. 1 are provided, each with their own electrolyte layer, and are arranged and joined in mirror-image relation with their respective electrolyte layers facing each other.

Alternatively, the electrolyte 16 may be formed of only a single electrolyte layer. This may be the case if a first structure 10 of the type shown in FIG. 1 is provided, and further electrode and current collector layers 14c, 12c are arranged directly onto the electrolyte 16 of the first structure. In this structure, the single electrolyte layer 16 forms a part of both the anode structure 10a and the cathode structure 10c.

Considering the constituent parts on more detail, the current collector 12 is a thin layer of a conducting material. The exact material of the current collector 12 will depend on the electrode material, but is typically a metal, such as aluminium or copper. The metal layer may be provided as a foil, and typically has a thickness of between 5 and 20 microns.

The electrode 14 comprises a layer of electrode material. Where the electrode is an anode 14a, the electrode material is an anode material capable of releasing positive ions during discharge, and where the electrode is a cathode 14c, the electrode material is a cathode material capable of accepting positive ions during discharge. The positive ions may be alkali metal ions, for example lithium ions and/or sodium ions. Example anode and cathode materials for a lithium-ion structure are shown in Table 1 below.

TABLE 1

| | Cathode materials: |
|---|---|
| Anode materials | lithium-rich versions of the following |
| Li | Lithium Manganese Oxide LiMn₂O₄ |
| Graphite | Lithium Cobalt Oxide LiCoO₂ |
| Lithium titanium | Lithium Iron Phosphate LiFePO₄ |
| oxide (Li₄Ti₅O₁₂) | |
| Li—Si alloy | Lithium Nickel Manganese Cobalt |
| | Oxide (Li(NiₓMn_{y}Co_{1-x-y})O₂) |
| Other lithium-transition | Lithium Nickel Cobalt Aluminum Oxide |
| metal alloys | (Li(NiₓCo_{y}Al_{1-x-y})O₂) |

The electrolyte 16 is a gel polymer electrolyte that comprises a gel matrix formed from a polymer and a solvent. One or more electrolyte components are loaded into the gel matrix. The electrolyte is capable of carrying the species of ion that is released by the anode and received by the cathode. Typically, the electrolyte is an ionic salt of the relevant ion species. Additional fillers such as ceramic nano-particles may be added to the gel electrolyte to improve its mechanical properties: in this case, the gel polymer electrolyte is a composite gel polymer electrolyte.

Example polymers and solvents suitable for incorporation into a gel polymer matrix, and example electrolyte components, are shown in Table 2 below.

TABLE 2

| Polymer | Solvent | Electrolyte |
|---|---|---|
| Poly(ethylene carbonate) EC | Poly(propylene carbonate) PC | LiClO₄ |
| Poly(propylene carbonate) PC | Poly(ethylene carbonate) EC | LiPF₆ |
| Poly(vinylene carbonate) VC | Other suitable carbonate | LiBF₄ |
| | electrolytes | |
| Poly(ethylene oxide) (PEO) | | LiAsF₆ |
| Poly(acrylonitrile) (PAN) | | LiTf |
| Poly(methyl methacrylate) | | Lilm |
| (PMMA) | | |
| Poly(vinylidene fluoride) | | |
| (PVdF) | | |
| Poly(vinylidene | | |
| fluoride-hexafluoro | | |
| propylene) (PVdF-HFP) | | |

The electrolyte gel is sufficiently viscous that the gel can be extruded, and holds it shape when arranged in the electrode-electrolyte structure. The exact viscosity depends on the proportion of solid constituents in the gel. Typically the electrolyte gel has a viscosity in the range of 2,000 Pa·S to 100,000 Pa·S.

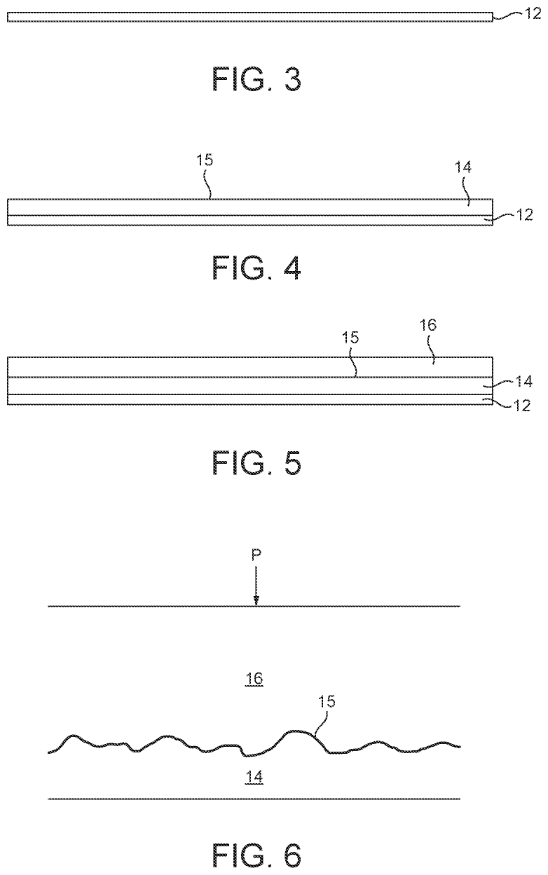

FIGS. 3 to 5 illustrate steps in a method of making the electrode-electrolyte structure 10 of FIG. 1.

First, as shown in FIG. 3, the current collector 12 is provided. Next, as shown in FIG. 4, the electrode 14 is formed on top of the current collector 12, by slurry casting. Any suitable slurry casting method may be used. In general, to form an electrode by slurry casting, a powdered electrode material is mixed with a solvent to form an electrode slurry. The slurry is applied to the current collector 12 then heated to evaporate the solvent, leaving the electrode material in place on the current collector 12.

The electrode 14 comprises an electrode surface 15 that lies opposite the current collector 12. After slurry casting is complete, the electrode surface 15 is a free (i.e. exposed) surface. As best seen in FIG. 6, because the electrode 14 has been formed by slurry casting, from a particulate material, the electrode surface 15 is also rough or porous, having surface pores.

In the next stage, shown in FIG. 5, the electrolyte 16 is extruded onto the electrode surface 15 to lie over the electrode 14. The electrolyte 16 may be extruded by any suitable extrusion method. In general, to extrude an electrolyte 16, the electrolyte material is forced through a die head of a predetermined size and shape that corresponds to a desired cross-section of the electrolyte 16.

Referring to FIG. 6, as the extruded electrolyte 16 is arranged on the electrode surface 15, the polymer gel of the extruded electrolyte 16 fills the surface pores of the electrode surface 15. The combination of the slurry cast electrode with the extruded gel polymer electrolyte is particularly advantageous because of this effect. Extruding the polymer gel onto the surface of the electrode causes the pores to be filled in this way, which provides excellent contact between the electrolyte and the electrode, which can otherwise be difficult to achieve. The high contact rate improves cell performance. Penetrating the pores in this way also improves adhesion.

Pore-filling may be further encouraged by applying a pressure P to the electrolyte 16 during, or after, the extrusion process. The pressure P is applied in a direction that is generally perpendicular to the electrode surface 15, i.e. generally perpendicular to an electrode-electrolyte interface. Pressure may be applied by any suitable method, for example using rollers in a calendaring process. Heat may also be applied as pressure is applied to aid adhesion.

The method described above may be carried out as a ‘batch’ process on individual sheets of current collector layers, or it may be carried out as a continuous process. In that case, a continuous roll of current collector may be fed through an electrode casting station, for slurry casting of the electrode, and the cast electrode may be fed as a continuous roll through an electrolyte extrusion station, in which the electrolyte is extruded onto the electrode.

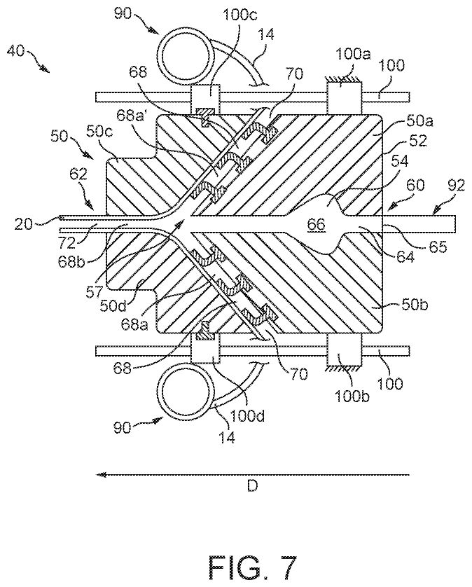

FIGS. 7 to 14 illustrate apparatus 40, 140 for extruding an electrolyte 16, 16′ onto an electrode substrate 14, 14′, 20. The electrode substrate may be an electrode 14, 14′, which may or may not be supported on a current collector layer. The electrode substrate may also be a pre-formed electrode-electrolyte structure 20 that comprises an electrode 14.

FIGS. 7 to 10 illustrate apparatus 40 for extruding an electrolyte onto an electrode substrate. The apparatus may be used as an extrusion station to implement the method described above, in which the electrode substrate is a slurry cast electrode and the electrolyte is extruded onto the slurry cast electrode. However, the apparatus may be used to implement other methods. For example, the electrode may not be a slurry cast electrode, but may be an electrode formed by other means: for example, an extruded electrode, or a PVD-deposited electrode. The electrode may be supported on a current collector layer, or the electrode may be free-standing.

Referring to FIG. 7, the apparatus 40 comprises a die head 50, an electrode feeder 90, for feeding one or more electrodes 14 to the die head 50, and a electrolyte feeder 92 for feeding electrolyte 16 to the die head 50 for extrusion onto the electrode 14.

The electrode feeder 90 may be any suitable supply means, and is exemplified here as an electrode roll, configured to rotate to dispense the electrode 14. In this case the electrode is a continuous strip. The electrolyte feeder 92 can be any suitable means for supplying a gel polymer electrolyte to the die head 50, at a pressure sufficient to provide extrusion: for example, an electrolyte pump or injector.

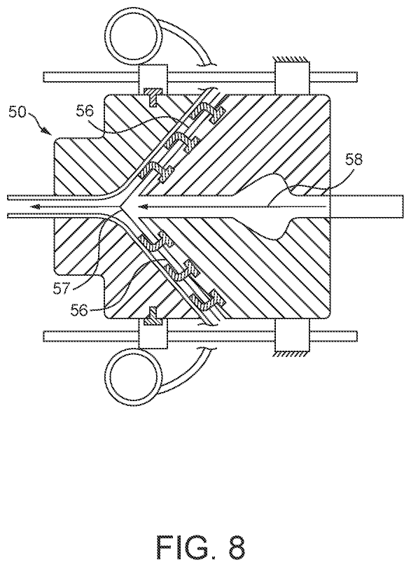

The die head comprises a body 52 with an opening 54 defined in the body 52. The opening 54 is made up of a series of passages and chambers that define pathways through the die head 50. As best seen in FIG. 8, the opening 54 defines a substrate pathway, which in this case is an electrode pathway 56 through which the electrode can pass, and an electrolyte pathway 58 through which the electrolyte can pass. The electrolyte pathway 58 intersects the electrode pathway 56 at a junction 57, such that the electrolyte pathway 58 delivers electrolyte 16 to the electrode 14.

Referring again to FIG. 7 and considering the opening 54 in more detail, the opening 54 has a proximal end 60 that is generally adjacent to the electrolyte feeding means 90, and a distal end 62 opposite the proximal end 60. A process direction D is defined moving from the proximal end 60 to the distal end 62.

The electrolyte pathway is defined by an electrolyte passage 64 that extends from the proximal end 60 to the junction 57 in a direction generally parallel to the process direction D. At the junction 57, the electrode passage 64 terminates in a distal opening 67 that acts as an extrusion opening. At the proximal end 60, the electrolyte passage 64 comprises an electrolyte entry opening 65 that permits entry of the electrolyte 14 in the electrolyte passage 64. In the regions closest to the opening 65 and the junction 57, the electrolyte passage 64 has a generally rectangular cross section in a plane perpendicular to the process direction D.

Between the proximal end 60 and the junction 57, the electrolyte passage 64 opens into a dwell chamber 66. A height of the electrolyte passage 64 in the region of the dwell chamber 66 is greater than a height of the electrolyte passage 64 elsewhere. The dwell chamber 66 is a coathanger manifold that is configured to provide a constant flow rate of electrolyte.

The electrode path is defined by a substrate passage, in this case an electrode passage 68. The electrode passage 68 comprises a first or entry section 68a, and a second or exit section 68b. In the example shown, the electrode passage 68 comprises two entry sections 68a, 68′, which converge into a single exit section 68b. Each of the entry sections 68a, 68a′ can receive a different electrode 14, both of which are fed towards the common exit section 68b.

Each entry section 68a, 68a′ extends from a substrate inlet 70 towards the junction 57, at an acute angle to the process direction. In this way, the entry sections 68a, 68a′ extend towards each other (i.e. converge) as they extend towards the junction 57 in the process direction D. The exit section 68b extends from the junction 57 to the distal end 62, parallel to the process direction. At the distal end 62, the electrode passage comprises a substrate outlet 72 through which an electrode-electrolyte structure 20 exits the die head 50.

As will be appreciated from FIG. 7, the electrolyte passage 64 is parallel to the exit section 68b of the electrode passage 68. Where the electrolyte passage 64 intersects the electrode passage 68 at the junction 57, the electrolyte passage 64 therefore runs continuously into the exit portion 68b of the electrode passage 68, to deliver the electrolyte smoothly into the electrode passage 68.

The die head body 50 comprises four body sections 50a, 50b, 50c, 50d: upper and lower proximal sections 50a, 50b and upper and lower distal sections 50c, 50d. The sections 50a, 50c, 50d are shaped and arranged to define the electrolyte passage 64 and the electrode passage 68 between them.

Specifically, the electrolyte passage 64 is defined between the upper and lower proximal sections 50a, 50b. The entry section 68a of the electrode passage 68 is defined between the upper distal region 50c and the upper proximal region 50a (or between the lower distal region and the lower proximal region 50b). The exit section 68b of the electrode passage 68 is defined between the upper distal region 50c and the lower distal region 50d.

The body sections 50a, 50b, 50c, 50d are movably mounted on rails 100 via mounts 100a, 100b, 100c, 100d. Each mount 100a, 100b, 100c, 100d comprises a bore that can receive the rail 100, to allow sliding movement along the rail, and a releasable fixing means (not shown) to fix the mount in place. The rails 100 are also moveable towards and away from each other and/or the mounts 100a are configured such that the body sections 50a, 50b, 50c, 50d are moveable towards and away from the rails 100.

Relative movement amongst the rails 100 and the body sections 50a, 50b, 50c, 50d allows the widths of the electrolyte passage 64 and the entry and exit sections 68a, 68b of the electrode passage 68 to be altered according to requirements. For example, the widths may be altered according to the thickness of the electrode substrate that is fed into the die head 50, or the desired thickness of the electrolyte that is to be deposited on the electrode substrate.

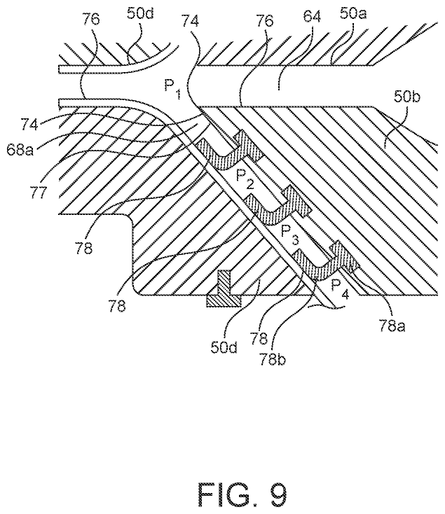

FIG. 9 shows a close up of the electrolyte passage 64 and the electrode passage 68 in the region of the junction 57.

As can be seen in this figure, a distal end 74 of each of the upper and lower proximal body sections 50a, 50b, which lies in the region of the junction 57, defines a sharp edge. More specifically, referring to the lower proximal body section 50b, a horizontal surface 76 of the body section 50b that partially defines the electrolyte passage 64, and a distal surface 77 of the body section 50b that partially defines the entry section 68a of the electrode passage 68, meet at an acute angle to define a pointed edge 74. This pointed edge 74 is beneficial as it prevents the electrolyte dripping backwards into the electrode passage 68 when the apparatus is in use. It is particularly beneficial in respect of the lower entry section 68a, since gravity will encourage this backward dripping action.

As can also be seen in this figure, the entry section 68a of the electrode passage 68 houses multiple sealing means 78. The sealing means 78 take the form of flexible brushes that extend along the depth of the electrode passage. Each brush comprises a root 78a that is embedded in, or otherwise coupled to, the body section 50b at the distal surface 77, and a sealing portion 78b that extends away from the distal surface 77 to project into the electrode passage 68.

The sealing portion 78b comprises one or more elongate protrusions. In this embodiment, the sealing portion comprises a flexible brush. The sealing portion is made from a flexible material such as a polymeric material. A length of the sealing portion 78b from the root 78a to its tip is greater than a width of the entry section 68a of the electrode passage 68. In this way, the sealing portion 78b must be deflected so that it can be accommodated within the electrode passage 68. The sealing portion 78b is specifically deflected so that it bends in a downstream direction moving away from the root portion 78a. In other words, the sealing portion 78b is deflected in a direction generally towards the junction 57. The sealing portion 78b may have an inherent curvature in this downstream direction, though this need not be the case.

The sealing portions 78b carry out several functions. Firstly, the sealing portions 78 apply a small force to the electrode 14, which tends to force the electrode 14 against the surface of the electrode passage 68 that is defined by the distal body portion 50c, 50d. This ensures that the electrode 14 is flat and in a pre-determined position as it reaches the junction 57. Secondly, the sealing portions 78b seal successive portions of the electrode passage 68, so that electrolyte cannot enter the electrode passage 68 to contaminate the electrode 14.

Thirdly, the sealing action creates a pressure differential along the electrode passage 68 moving away from the junction 57. In the junction region 57, pressure is at a level P1. This pressure is relatively high, and higher than atmospheric pressure, so as to prevent loss of solvents in the electrolyte through evaporation. The pressure is at a successively reduced behind each successive sealing portion 78b: behind the first sealing portion 78b the pressure is P2, behind the next sealing portion 78b the pressure is P3, and behind the second sealing portion 78b the pressure is P4, where P1>P2>P3>P4. This gradual increase in pressure towards the junction 57 reduces the overall pressure gradient, which reduces leakage of the pressurising gas from the junction region 57. A smaller or greater number of sealing means with different pressures may be used.

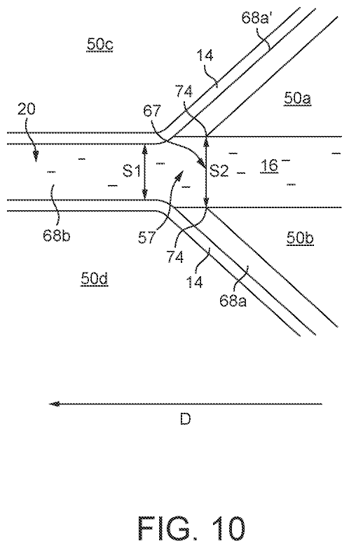

Use of the apparatus 40 in making an electrode-electrolyte structure 20 will now be described with reference to FIGS. 7 and 10. First, the body portions 50a, 50b, 50c, 50d are set in the desired position, so as to set the widths of the electrolyte passage 64 and the electrode passage 68 as required. Pressure is then applied to the junction region 57 and successive regions of the electrode passage 68. In this state, the apparatus is ready for use.

The electrodes 14 are supplied to the die head 50 by the electrode supply means 90, such that the electrodes 14 travel through the electrode passage 68, from the entry opening 70 to the exit opening 72 via the junction 57. In this case, one of the electrodes is an anode and one of the electrodes is a cathode. Where the electrode 14 is provided as an electrode structure comprising a current collector layer and an electrode layer, the electrode structure is arrange such that the current collector layer lies against the die head 50, and the electrode layer faces outward, into the electrode passage 68.

Simultaneously, electrolyte is supplied to the die head 50 by the electrolyte supply means 92, such that the electrolyte travels from the proximal opening 65 to the junction 57, via the dwell chamber 66, at a constant flow rate. The electrolyte is supplied under pressure, for example a pressure of approximately 1 bar to approximately 10 bar, so as to provide the force necessary for extrusion.

FIG. 10 is a close up of the region around the junction 57 while extrusion takes place.

At the junction 57, the electrode passage 68 transitions from separate entry sections 68a, which are at acute angles to the process direction D, to the common exit section 68b, which is parallel to the process direction D. The two electrodes 14, fed from different directions, therefore converge as they reach the junction point. As they enter the exit section 68b, an electrode spacing S1 is defined between them. The electrodes subsequently travel along opposite surfaces of the same exit section 68b of the electrode passage 68.

As the electrolyte 16 reaches the junction 57, the electrolyte 16 is extruded out of the electrolyte passage 64 into the junction region 57. The electrolyte 16 is extruded out of the distal opening 67 of the electrolyte passage 68, between the distal edges 74. A spacing S2 between the distal edges 74 defines a height of the extruded electrolyte 16.

The electrolyte 16 is extruded into the junction 57 at a location between the two electrodes 14. The height S2 of the extruded electrolyte is substantially the same as, or slightly greater than, the electrode spacing S1 between the electrodes 14 at their point of convergence. In this way, the extruded electrolyte 16 is fed and accommodate between the electrodes 14.

As the electrodes 14 continue moving in the process direction D, the extruded electrolyte 16 is captured and sandwiched between the electrodes 14, and hence continues to travel in the process direction D with the electrodes 14. In this way, the interruption of the electrode passage 68 by the electrolyte passage 64 causes the electrolyte to be extruded directly between the electrodes 14 to create the electrode-electrolyte structure 20.

In the exit section 68b of the electrode passage 68, the electrode-electrolyte structure 20 continues to move together in the process direction D. The electrode passage 68 in this region 68b is configured to apply a slight pressure, for example approximately 1 KPa to approximately 1 MPa to the electrode structure. In this way, as the electrode-electrolyte structure 20 travels through the exit section 68b of the electrode passage 68, the gel electrolyte 16 is compressed between the electrodes 14. A pressure is therefore applied to the gel electrolyte 16 in a direction substantially perpendicular to the electrode-electrolyte interface. This pressure adheres the gel electrolyte 16 to the electrodes 14. Where the electrodes are slurry cast electrodes of the type described above, the pressure also assists the gel electrolyte 16 in penetrating the pores of the porous electrode surface. The electrode-electrolyte structure 20 may also be heated to aid adhesion, for example by heating the die body 52, or by heating the electrode structure after it has exited the die body 52.

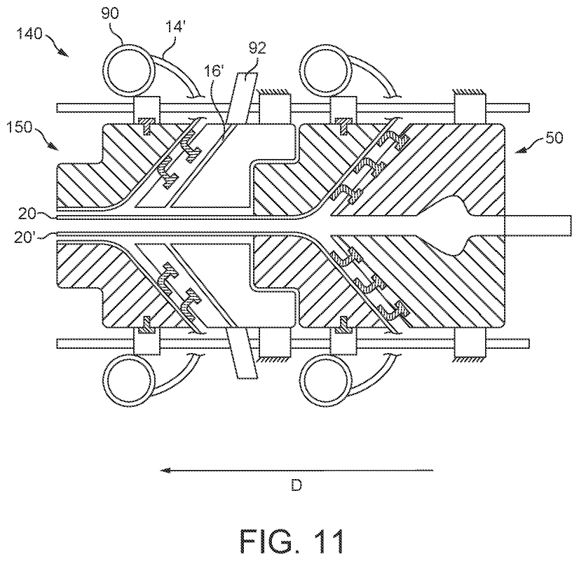

FIG. 11 illustrates an apparatus 140 that can be used to make more complex electrod-electrolyte structures having multiple electrolyte layers. The apparatus 140 comprises the apparatus 40 of FIG. 7 with the die head 50 of FIG. 7 forming a first die head part. The apparatus 140 also comprises a further die head 150 forming a second die head part. The second die head part 150 is arranged downstream of the first die head part 50 in the process direction D. In this example, the first die head part 50 and second die head part 150 are formed as separate die head modules that can be used separately or together. However, embodiments are also envisaged in which the first and second die head parts 50, 150 are part of the same module.

The second or further die head part 150 is configured for onward processing of the electrode-electrolyte structure 20 produced by the first die head module 50. In this way, the electrode-electrolyte structure produced by the first die head module 50 forms a pre-form structure 20 that is processed by the further die head part 150. The pre-form defines an electrode substrate during this onward processing.

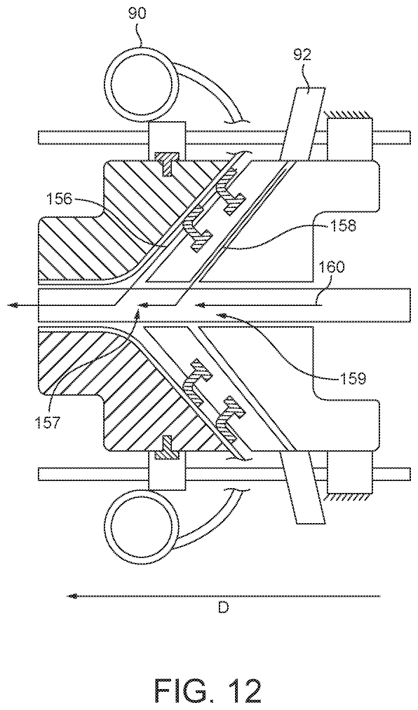

FIG. 12 shows the further die head part 150 in isolation. The further die head part 150 is generally similar to the die head part 50 of FIG. 10, but comprises additional pathways to accommodate the fact that additional processing must use the pre-form structure.

In particular, the die head part 150 of FIG. 12 defines two different substrate pathways: A first substrate pathway in the form of an electrode pathway 156 through which an electrode can travel, and a second substrate pathway in the form of an electrode-electrolyte structure pathway or pre-form pathway 160, through which an electrode-electrolyte pre-form 20 can travel. The die head part 150 also defines an electrolyte pathway 158 through which an electrolyte can be extruded.

The pre-form pathway 160 interrupts the electrolyte pathway 158 at a first junction 159, where electrolyte 116 is extruded onto the electrode-electrolyte structure 20. The electrolyte pathway 158 interrupts the electrode pathway 156 at a second junction 157, where an electrode 114 is arranged over the electrolyte 116. In this way, both the electrode-electrolyte structure 20 and the electrode 14 act as electrode substrates onto which electrolyte can be extruded or otherwise layered.

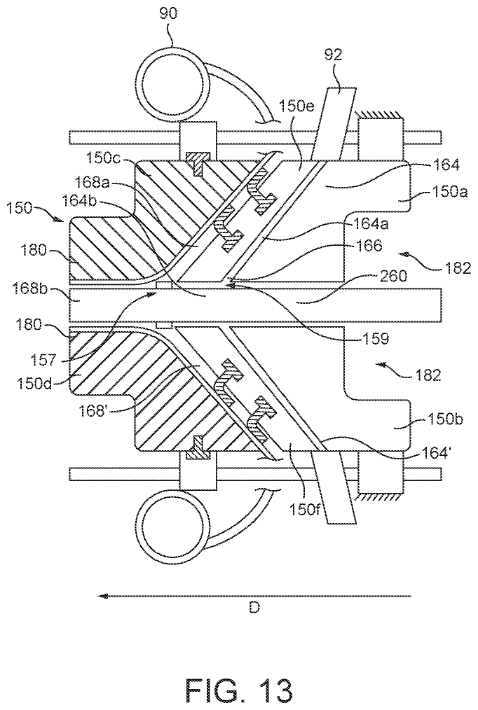

Considering the passages in more detail, and referring to FIG. 13, the pre-form pathway 160 is defined by a pre-form passage 260, that extends substantially parallel to the process direction D. The pre-form passage 260 extends from a proximal end of the die head 50 to the first junction 159.

The electrolyte pathway is defined by an electrolyte passage 164 that is supplied with electrolyte by an electrolyte supply means 92. The electrolyte passage 164 extends from an entry opening 165 towards the second junction 157 via the first junction 159.

The electrolyte passage 164 comprises two regions. An entry section 164a extends from the 35 entry opening 165 to the first junction 159 at an acute angle to the process direction D. The entry section 164a terminates in an extrusion opening 166 that opens onto the pre-form passage 260 at the first junction 159. An exit section 164b extends from the first junction 159 to the second junction 157 generally parallel to the process direction D. The exit section 164b terminates in an exit opening 167 through which the electrolyte exits the electrolyte passage 164.

The electrode path is defined by an electrode passage 168 that comprises first and second regions 168a, 168b. The entry section 168a extends from an entry opening 170 towards the second junction 157, at an acute angle to the process direction D. The exit section 168b extends from the second junction 157 to a distal end 162 of the die head 150, in a direction that is parallel to the process direction D.

As will be appreciated from FIG. 13, the pre-form passage 260 is parallel to the exit section 164b of the electrolyte passage 164. Where the pre-form passage 260 intersects the electrolyte passage 164 at the first junction 159, the pre-form passage 260 runs continuously into the exit section 164b of the electrolyte passage 164, to deliver the electrode-electrolyte structure 20 smoothly into the electrolyte passage 164.

Similarly, the exit section 164b of the electrolyte passage 164 is parallel to the exit section 168b of the electrode passage 168. Where the electrolyte passage 164 intersects the electrode passage 168 at the second junction 157, the electrolyte passage 164 runs continuously into the exit section 168b of the electrode passage 168, to deliver the pre-form with coated electrolyte 116 smoothly into the electrode passage 68.

A corresponding first region 168a′ of the electrode passage 168 and first region 164′ of the electrolyte passage 164 are provided on the opposite side of the die head 150.

The die head part 150 of FIG. 12 comprises a die head body 152. The die head body 152 comprises upper and lower proximal sections 150a, 150b, upper and lower distal sections 150c, 150d, and upper and lower central sections 150e, 150f. The sections are shaped to define the various passages between them.

Specifically, the pre-form passage 260 is defined between the upper and lower proximal portions 150a, 150b. The entry section 164a of the electrolyte passage 164 is defined between the upper proximal section 150a, and the upper central section 150e. The exit section 164b of the electrolyte passage 164 is defined between the upper central portion 150e and the lower central portion 150f. The entry section 168a of the electrode passage 168 is defined between the upper distal region 150c and the upper central region 150e. The exit section 168b of the electrode passage 168 is defined between the upper distal region 150c and the lower distal region 150d.

The die head part 150 comprises distal and proximal locating features that are configured to locate the further die head part 150 relative to an adjacent die head part 50 when the modular die heads are arranged together for use. A distal end of the die head part 150, and in particular distal ends of the distal sections 150c, 150d, comprises protrusions 180, while a proximal end of the die head 150, and in particular proximal ends of the proximal sections 150a, 150b, comprise corresponding recesses or cut-outs 182. Referring back to FIG. 11, the protrusions of one die head part 50 are received in the recesses of a neighbouring die head part 150 when the die head parts 50, 150 are arranged for use, thereby locating the die head parts modules 150 relative to one another.

It will be appreciated that comparable features described above in relation to the die head part 50 of FIG. 7 also apply to the die head part 150 of FIG. 12. For example, the entry portions 168a of the electrode passages 168 comprise the same sealing means. The body sections 150b, 150c, 150d, 150e, 150f are movably mounted to movable rails in the same way. Other common features are substantially the same and will not be repeated in detail.

Referring again to FIG. 11, to use the modular apparatus 140 in making a complex electrode-electrolyte structure 20′, both die head parts 50, 150 are first set in the desired position, so as to set the widths of the various passages as required. Pressure is then applied to the junction regions 57, 157 as previously described, and the apparatus is ready for use.

The electrodes 14, 14′ are supplied to the die head parts 50, 150 by the electrode supply means 90, such that the electrodes 14, 14′ travel through the electrode passages 68, 168. Simultaneously, electrolyte is supplied to the die head parts 50, 150 by the electrolyte supply means 92 as described above.

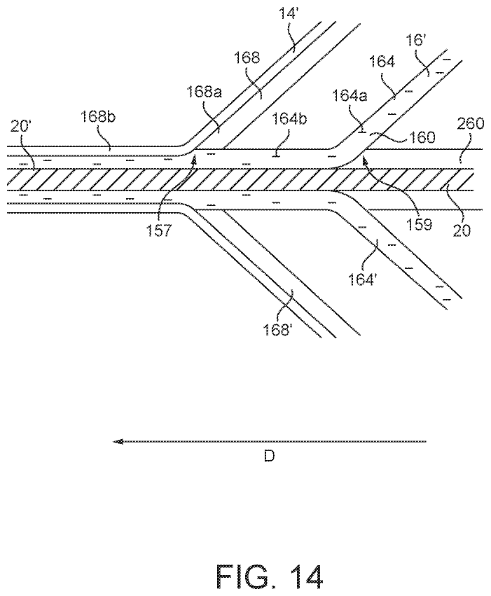

In the first die head part 50, the process follows the method already described above to make the electrode-electrolyte structure 20. The electrode-electrolyte structure 20 then exits the first die head 50 and enters the second die head part 150 as the pre-form structure for onward processing. The process in the second die head part 150 is shown schematically in FIG. 14.

The pre-form 20 enters second die head part 150 via the pre-form passage 260. Simultaneously, electrolyte 16′ is supplied to the electrolyte passage 164. At the first junction 159, the electrolyte passage 164 transitions from the entry section 164a to the exit section 164b. As the electrolyte 16′ reaches the first junction 159, the electrolyte is extruded out of the entry section 164a onto the pre-form 20, via the extrusion opening 166.

The pre-form 20 and extruded electrolyte 16′ then continue travelling down the exit section 164b of the electrolyte passage 164 until they reach the second junction 157.

At the second junction 157, the electrode passage 168 transitions from the entry section 168a to the exit section 168b. As the pre-form 20 and extruded electrolyte 16′ travel through the second junction 157 and into the exit section 168b of the electrode passage 168, the electrode is laid on top of the extruded electrolyte 16′.

The combine structure 20′, comprising the pre-form 20, the electrolyte 16′ and the electrode 14′ continues through the exit section 168b of the electrode passage 168, and eventually exits the second die head 150. Similar to the exit section 68b of the electrode passage 68 of the first die head 50, the exit section 168b of the electrode passage 168 of the second die head 150 may be configured to apply pressure and/or heat to the electrolyte 16′ to aid adhesion.

It will be appreciate that the corresponding entry section 164a′ of the electrolyte passage 164 and corresponding entry section 168a′ of the electrode passage 168′, which are arranged on the opposite side of the pre-form, provide corresponding means for simultaneously depositing a further electrolyte layer and a further electrode layer on the opposite side of the pre-form 20, so as to build a symmetrical structure.

Further layers can be added to one of both sides of the structure using further die head modules as required. In that case, the structure 20′ acts as a pre-form for a further die head module. The convenient mounting system and easy interlocking of the modules means that any number of die head modules can be used in succession, and can be removed, added or interchanged as necessary.

The apparatus therefore provides convenient means of extrude a gel electrolyte onto an electrode, an in some cases between electrodes, in a continuous manner. Multiple different layers can be easily added to the structure in a single process. The apparatus is versatile, and easily adapted to any particular desired structure, and any desired number of layers.

It should be appreciated that although the electrode passage 68 of the die head module 50 of FIG. 7 is provided with two entry sections 68a, this need not be the case. Embodiments are envisaged in which only a single entry section 68a is provided, such that the electrolyte is extruded onto a single electrode, rather than being extruded between electrodes. In this case an additional electrode may be added during subsequent processing if required.

Similarly, although the electrode passage 168 and electrolyte passage 164 of the die head module 150 of FIG. 12 are each provided with two entry sections 168a, 164a this need not be the case. Embodiments are envisaged in which only a single entry section 164a, 168a is provided, such that a single layer of electrolyte is extruded onto the pre-form, and an electrode is applied to that single layer of electrolyte.

It should also be appreciated that the second die head module 150 may be used in isolation in an apparatus, or may be used as the first die head module amongst a series of die head modules. This may be appropriate if a pre-form electrode-electrolyte structure is made at a different site, or using a different method, and is fed directly into the second die head module 150.

1. Apparatus for applying a polymer gel electrolyte to an electrode substrate to make an electrode-electrolyte structure, the apparatus comprising:
a die head defining a substrate pathway for passage of the electrode substrate through the die head from a substrate inlet to a substrate outlet, and an electrolyte pathway for passage of the electrolyte gel through the die head;
an electrode feeder for feeding the electrode substrate along the substrate pathway, the electrode feeder comprising a roll of electrode substrate; and
an electrolyte feeder for feeding the polymer gel electrolyte along the electrolyte pathway;
wherein the electrolyte pathway is arranged to meet the substrate pathway at a junction arranged between the substrate inlet and the substrate outlet, to extrude the electrolyte onto the electrode substrate as it is fed along the substrate pathway.

2. The apparatus of claim 1, wherein the die head defines a process direction, and wherein the substrate pathway comprises an entry section extending from the substrate inlet to the junction arranged at an acute angle to the process direction, and an exit section extending from the junction to the substrate outlet arranged substantially parallel to the process direction.

3. The apparatus of claim 2, wherein the substrate pathway comprises first and second entry sections arranged to feed first and second electrode substrates to opposite sides of the exit section at the junction.

4. The apparatus of claim 2, wherein at least a part of the electrolyte pathway is parallel to and continuous with the exit section of the substrate pathway.

5. The apparatus of claim 1, wherein the substrate pathway is defined by a substrate passage formed in the die head.

6. The apparatus of claim 5, wherein the electrolyte pathway is defined by an electrolyte passage formed in the die head, and wherein the electrolyte passage converges with the substrate passage at the junction.

7. The apparatus of claim 6, wherein the die head defines a process direction, and wherein the substrate pathway comprises an entry section extending from the substrate inlet to the junction arranged at an acute angle to the process direction, and an exit section extending from the junction to the substrate outlet arranged substantially parallel to the process direction, and wherein the electrolyte passage meets the entry portion of the substrate passage at an acute angle to define an extrusion edge.

8. The apparatus of claim 6, wherein the electrolyte passage defines a dwell chamber for receiving excess electrolyte.

9. The apparatus of claim 5, wherein the substrate passage comprises a plurality of sealing means for sealing the entry section of the substrate passage from the electrolyte passage, wherein the plurality of sealing means is spaced successively along the entry section moving away from the junction.

10-11. (canceled)

12. The apparatus of claim 1 wherein the junction is pressurised to a junction pressure greater than atmospheric pressure.

13. The apparatus of claim 12, wherein the substrate passage comprises a plurality of sealing means spaced successively along the entry section moving away from the junction, and wherein a pressure behind each sealing means decreases moving away from the junction.

14. The apparatus of claim 1, wherein the die head comprises mounting means for movably mounting the die head on a support.

15. The apparatus of claim 1, wherein the die head comprises a plurality of sections arrangeable to define the electrolyte pathway and the substrate pathway therebetween.

16. The apparatus of claim 15, wherein the die head comprises mounting means for movably mounting the die head on a support and wherein each section comprises a mounting means for movably mounting the section on the support, thereby allowing relative movement between the die head sections to adjust dimensions of the electrolyte pathway and the substrate pathway.

17. The apparatus of claim 16, wherein the die head comprises first and second proximal sections and first and second distal sections, wherein the electrolyte pathway is defined between the first and second proximal sections, and wherein the substrate pathway is defined at least partially between the first proximal section and the first distal section, and at least partially between the first distal section and the second distal section.

18. (canceled)

19. The apparatus of claim 1, wherein the die head comprises a first die head part defining the electrolyte pathway and the substrate pathway, and a second die head part, the second die head part defining
a first further substrate pathway configured to receive an electrode-electrolyte structure produced by the first die head part,
a further electrolyte pathway configured to allow passage of a polymer gel electrolyte through the second die head part; and
a second further substrate pathway configured to receive a further electrode substrate;
wherein the further electrolyte pathway is arranged to meet the first further substrate pathway at a first junction, to extrude the polymer gel electrolyte onto the electrode-electrolyte structure as it is fed along the first further substrate pathway; and
wherein the further electrolyte pathway is configured to meet the second further substrate pathway at a second junction downstream of the first junction, to arrange the further electrode substrate over the polymer gel electrolyte, thereby producing an electrode-electrolyte structure having multiple electrolyte layers.

20. The apparatus of claim 19, wherein the second die head part defines a process direction, wherein the further electrolyte pathway comprises an entry section that extends towards the first junction at an acute angle to the process direction, and an exit section that extends between the first junction and the second junction in a direction parallel to the exit section.

21. The apparatus of claim 20, wherein the first further substrate pathway is parallel to and continuous with the exit section of the further electrolyte pathway.

22. The apparatus of claim 19, wherein the first die head part and the second die head part are defined by separable die head modules.

23-24. (canceled)

25. A method of applying a polymer gel electrolyte to an electrode substrate, the method comprising the steps of:
providing a die head defining a substrate pathway for passage of the electrode substrate through the die head from a substrate inlet to a substrate outlet, and an electrolyte pathway for passage of the electrolyte gel through the die head;
feeding the electrode substrate along the substrate pathway from a roll of electrode substrate; and
feeding the polymer gel electrolyte along the electrolyte pathway;
wherein the electrolyte pathway is arranged to meet the substrate pathway at a junction arranged between the substrate inlet and the substrate outlet, to extrude the polymer gel electrolyte onto the electrode substrate as it is fed along the substrate pathway.

26. The method of claim 25, wherein the junction is pressurised to a junction pressure greater than atmospheric pressure.

27. The method of claim 25, wherein the electrode substrate comprises a current collector layer and an electrode layer formed on the current collector layer by slurry casting.

28. The method of claim 25, wherein the electrode layer comprises an electrode surface having surface pores, and the polymer gel electrolyte is extruded onto the electrode surface such that the polymer gel electrolyte at least partially fills the surface pores.
